(19) United States
(12) Patent Application Publication
(10) Pub. No.: US 2009/0209890 A1
(43) Pub. Date: Aug. 20, 2009

(54) Massaging apparatus

(76) Inventor: Hiroshi Nakamura, Tokyo (JP)

Correspondence Address: JACOBSON HOLMAN PLLC, 400 SEVENTH STREET N.W., SUITE 600, WASHINGTON, DC, 20004, US

(21) Appl. No.: 12/071,391

(22) Filed: Feb. 20, 2008

(51) Int. Cl. A61H 23/00

(52) U.S. Cl. 601/134; 601/49

(57) ABSTRACT

A massaging apparatus which is capable of strongly pressing and alleviating the stiffness of the muscle safely without causing displacement of the body of a user or the massaging apparatus by it self is provided. The massaging apparatus is formed with an obliquely projecting projection toward the root of the neck of the user when the user places the head in a stable manner in the lying-down position, so that it has an optimum structure and shape for finding and alleviating the stiffness of the pinpoint located at a deep portion at the boundary portion between the shoulder and a neck, which is specifically effective to give a massage for alleviating the stiffness.

### BACKGROUND OF THE INVENTION

1. Field of the Invention

The present invention relates to a massaging apparatus which is able to press-massage deep portions of the body around the shoulders and the neck easily, effectively and strongly in a relaxed lying-down position.

2. Description of the Related Art

Many people suffer from stiffness in the shoulders. There is a manipulation therapy practiced by a specialist as a method of alleviating the stiffness in the shoulder in the related art (see, for example, “Illustration/Basic Manipulation Method, Total Body Adjustment by Massage and Acupressure” published from Ishiyaku Pub Inc. Mar. 1, 2006, pp. 90-95, pp. 2-8).

There is high-grade chair-type massaging apparatus as an instrument for alleviating the stiffness in the shoulder in the related art (For example, see JP-A-2005-000259).

There is also a local massager (For example, see JP-A-2005-40288).

There is a belt-type massager which is invented on the basis of the massaging apparatuses shown above (for example, see JP-A-2001-198170)

The person who suffers from the stiffness in the shoulders feels like having strongest acupressure, massage and unstiffening and the effective pinpoints of the body for that are deep portion at a boundary portion between the shoulder and the neck. Massaging means shown above in the related art does not meet this need.

Problems of the manipulation therapy, the high-grade chair-type massaging apparatus, the local massager, and the belt-type massager will be described in sequence.

In the Illustration/Basic Manipulation Method, Total Body Adjustment by Massage and Acupressure, there is no description about a method of applying an effect of a safe and strong acupressure massage to the pinpoints at the deep portion at the boundary portion between the shoulder and the neck which are specifically effective for alleviating the stiffness in the shoulders and hence the strongest acupressure massage should be given.

Firstly, problems in the manipulation therapy practiced by the specialist will be described.

When the specialist practices the manipulation therapy, as shown in Illustration/Basic Manipulation Method, Total Body Adjustment by Massage and Acupressure (in particular, the upper left portion in p. 94, an illustration of a first row, first point (standing posture) in an interscapular portion), a patient takes a lying-down position, and a practitioner places both thumb tips to the deep portion at the boundary portion between the shoulder and the neck so as to be able to give a strong acupressure to the surface of the human body in the vertical direction and gives acupressure in a posture to place him/herself over the patient. In this manner, to give a strong pressure and massage is a hard and difficult practice in terms of physical energy and the reason that fingers may be damaged. In addition, since the practitioner is human being, and the practitioner cannot give the practice for a long time even when the patient asks the practitioner to give a strong acupressure only the point in question from the reasons such that it is too hard in terms of the physical energy, that the fingers may be damaged, or the practitioner has too much pride to do so. Furthermore, the practitioner might not be available at the time convenient for the patient, and the fee is too high as a matter of course.

Subsequently, problems of the high-grade chair-type massaging apparatus will be described.

The high-grade chair-type massaging apparatus as disclosed in JP-A-2005-000259, a method of massaging to alleviate the stiffness by giving massage so as to pinch the stiffed part of the body from both sides is employed. However, to give a strong acupressure as described above in Illustration/Basic Manipulation Method, Total Body Adjustment by Massage and Acupressure to the deep portion at the boundary portion between the shoulder and the neck is dangerous because the cervical vertebrae are pressed from both sides. Therefore, since a strong pressure cannot be applied, and hence only the practice such as 5. Basic Manipulation, 1) effleurage (method of rubbing lightly) shown in the middle of p. 3 of the reference can be applied which is not the acupressure strong enough for the deep portion at the boundary portion between the shoulder and the neck. Supposing that only one side is pressurized, the body of the user is displaced because of its structure and shape.

Most of the patients have different degree of stiffness between the left and right sides, but this apparatus can only give a massage to the deep portions at the boundary portion between the shoulders and the neck having different degree of stiffness equally to the left and right side. In addition, effective practice cannot be given to crookbacked patients who cannot keep a ramrod-straight posture because of old age or the like.

The problems of the local massager will be described.

The local massager disclosed in JP-2005-40288 does not have the structure and shape which are able to apply strong acupressure to the deep portions at the boundary portion between the shoulders and the neck.

When an attempt is made to take an unnatural posture and apply a strong pressure forcedly to the boundary portion between the shoulders and the neck, the range of movement of a distal portion of a pressing portion is large, and hence it rubs the skin and makes the skin painful.

Since it does not have the structure and shape which can resist the strong pressure, the problem occurs easily in its parts. When an attempt is made to apply a pressing force to the deep portion at the boundary portion between the shoulder and the neck, the body is displaced easily toward the head of the user.

In addition, since it is used in the face-up position, the line of vision is directed to a ceiling, and hence the user cannot have a practice in a relaxed state such as the state of watching a TV.

In order to have the practice while reading a book, the user has to support the book with the hands lifted upward, which is hard for the user.

Finally, the problems of the belt-type massager will be described.

As the belt-type massager described above, the belt-type massager as described in JP-A-2001-198170, which is used for alleviating the stiffness of the shoulders by wrapping around the shoulder, is proposed. However, it is used by pressing with both hands using also the hand and the shoulder on the side being massaged, and hence gives less effect and is very tiring to use.

Therefore, the patient suffering from the secondary disease of cerebral infarct cannot alleviate the stiffness of the shoulder and the neck on the side suffering from the hard secondary disease.

### SUMMARY OF THE INVENTION

In order to solve the problems of the configurations in the related art as described above, it is an object of the invention to realize a practice of an effective, highly efficient and strong acupressure safely for a sufficient required time period by a patient by him/herself, which could be realized only for a short time even by a specialist of manipulation only by taking a relaxed lying-down position which enables the practice against the stiffness in the deep portion at the boundary portion between the shoulder and the neck while enjoying the TV watching.

The invention is achieved after having devoted ourselves to study in order to solve the technical drawbacks in the related art, and is formed with a projection which projects obliquely toward the root of the neck of a user when the head is stabilized in the lying-down position.

Since the invented projection is configured to press directly a human body, deformable elastic material, flexible material as well as rigid member and hard member which are hardly deformed when being pressed are used, and the structure and material which give soft texture and sense of security when it touches the human body are employed.

Selectively, a projection is formed so as to project obliquely toward a portion near a seventh cervical vertebra of the user.

Selectively, a head rest portion for placing the head of the user is formed.

Selectively, a neck side projection for placing at a boundary portion between the head portion and the neck of the user is provided so as to face the obliquely projecting projection.

Selectively, the obliquely projecting projection is provided at an angle of 30 to 60° from a main body of a massaging apparatus.

Selectively, the obliquely projecting projection is drivable.

Selectively, the obliquely projecting projection is formed with a pinpoint massaging projection which is capable of being driven at the upper end thereof.

Selectively, the massaging apparatus is usable as a pillow.

Selectively, the massaging apparatus is usable as a bed.

Selectively, the obliquely projecting projection is provided at an arm rest and the massaging apparatus is usable as a sofa.

As describe thus far, the massaging apparatus in the invention is specifically effective for alleviating the stiffness in the shoulder, is capable of finding the pinpoints at the deep portion at the boundary portion between the shoulder and the neck to be acupressured with a strongest force, give a safe and strong acupressure massage effect to alleviate the stiffness, and is usable in a comfortable posture such as the lying-down position. The massaging apparatus which provides a high therapeutic effect is provided.

A type which applies the strong pressing force to the pinpoints at the deep portion at the boundary portion between the shoulder and the neck and alleviates the stiffness using a known drive unit is now able to effectively alleviate the stiffness which cannot be realized even with the manipulation practices by the specialist.

Advantageous effects of the invention in comparison with the manipulation therapy practiced by the specialist, the high-grade chair-type massaging apparatus, the local massager, and the belt-type massager in the related art will be described in sequence.

Firstly, the advantageous effects in comparison with the manipulation therapy practiced by the specialist will be described.

With the projection which projects obliquely toward the root of the neck of the user formed according to the invention, a strong acupressure, which used to be applied from above when the specialist practices the manipulation therapy, is applied to the deep portion at the boundary portion between the shoulder and the neck in the vertical direction with respect to the surface of the human body as a strong pressure applied from below when the person is stabilized his/her head thereon in the lying-down position.

Since the massaging apparatus in the invention has strength and employs a motive power, the patient is able to practice a desirably strong acupressure for a necessary sufficient time period irrespective of the physical energy, injury of the trouble of the finger, the pride of the practitioner. Furthermore, the apparatus can be used at the convenient time, and no fee is necessary in the case of the apparatus employing no motive power. Even with the type employing a motive power, the fee is very low. Consequently, a practice including 3) a strong acupressure with an oppressing method (pressing) in p. 5 of the reference, 2) a kneading method (kneading) in p. 4 of the reference, 6) strong rubbing method (strongly rubbing) in p. 7 of the reference in combination is enabled. Furthermore, by providing a vibrator function, manipulation and practice including 4) vibrating method (vibration) in p. 5 of the reference combined together, which cannot be achieved by human being, are enabled, so that a massage with high therapeutic effects is enabled.

Subsequently, the advantageous effect in comparison with the high-grade chair-type massaging apparatus will be described. The high-grade chair-type massaging apparatus in JP-A-2005-000259, a method of massaging so as to pinch from both sides to alleviate the stiffness is employed. However, since the massaging apparatus in the invention presses only one side strongly in the lying-down position, there is no danger to oppress the cervical vertebrae from the both sides and hence a strong pressure may be applied without causing the user's body to be displaced. Therefore, application of the practice to the deep portion at the boundary portion between the shoulder and the neck while differentiating the practice to the left side from the right side is enabled. Also, an effective practice is given to the crookbacked patients who cannot keep a ramrod-straight posture because of old age or the like.

Subsequently, advantageous effects in comparison with the local massager will be described.

Being different from the local massager disclosed in JP-A-2005-40288, the invention has structure and shape in which a strong acupressure is applied to the deep portion at the boundary portion between the shoulder and the neck. Since the weight of the head and the pressing force toward the head are applied, the apparatus is hardly displaced toward the head.

Since the clothe and the skin of the person to be massaged are hardly in friction in the massaging apparatus in the invention in which the range of movement of the distal end of the acupressure portion is not too large, the user hardly has a pain over his/her skin. Since the apparatus has the structure and shape which resist the strong pressure, the problem hardly occurs in its parts. With these advantages, as clearly described in lines 5 to 7, p. 3 in the reference, the user may have a pain over the skin unless the user pays an attention not to rub the skin with his/her finger. The manipulation, practice and method such that the user massages while moving his/her wrist and the joint of the elbow and holding the portion to be massaged with his/her hand so as not to release, and the manipulation, practice and method of a strong acupressure may be practiced simultaneously.

Since the massage is practiced in the lying-down position, the user can be massaged in a relaxed manner while watching the TV without watching the ceiling.

Also, when receiving the massage while reading the book, the user is able to read the book with his/her hands placed on the floor, which is comfortable.

Finally, advantageous effects in comparison with the belt-type massager will be described.

It is not necessary to push the portion to massage with both hands, and the practice with a strong pressure is achieved only by taking the relaxed lying-down position without using the hand and the shoulder on the side to give a massage as a matter of course, and also the both hands.

The patients suffering from the secondary disease of the cerebral infarct are now able to massage their shoulder and neck on the side suffering from the secondary disease effectively.

In addition, by providing a function as the massaging apparatus in beds, pillows, or armrests of the sofa, a strong acupressure and massage may be given to the deep portion at the boundary portion between the shoulder and the neck in the relaxed posture such as the lying-down position while effectively using the cushioning property of the bed and the sofa.

Also, a function as a machine to give the strong acupressure and massage to the deep portion at the boundary portion between the shoulder and the neck is achieved by using a space in the arm rest of the sofa, the bed and the pillow.

### BRIEF DESCRIPTION OF THE DRAWINGS

FIG. 1 is a side view showing a state of usage of a massaging apparatus according to the invention;

FIG. 2 is a side view showing a state of usage of the massaging apparatus according to the invention;

FIG. 3 is a side view showing a state of usage of the massaging apparatus according to the invention;

FIG. 4 is a side view showing a state of usage of the massaging apparatus according to the invention;

FIG. 5 illustrates perspective views showing several examples of the massaging apparatus according to the invention;

FIG. 6 illustrates several examples of projections of the massaging apparatus according to the invention, wherein (1) to (4) are plan views, (5) to (8) are perspective views and (9) and (10) are side views;

FIG. 7 is a perspective view of an example of the massaging apparatus according to the invention;

FIG. 8 illustrates a state of usage of the massaging apparatus according to the invention and examples of the massaging apparatus according to the invention, wherein (1) is a side view showing a state of usage of the massaging apparatus according to the invention, (2) to (4) and (7) are side views showing examples of the massaging apparatus according to the invention, and (5) and (6) are plan views showing examples of the invention;

FIG. 9 illustrates a state of usage of the massaging apparatus according to the invention, wherein (1) is a side view and (2) is a plan view;

FIG. 10 is a side view showing another state of usage of the massaging apparatus according to the invention;

FIG. 11 illustrates the massaging apparatus according to the invention, wherein (1) and (2) are side views;

FIG. 12 is a side view showing another state of usage of the massaging apparatus according to the invention; and

FIG. 13 illustrates a still another state of usage of the massaging apparatus according to the invention and the massaging apparatus, wherein (1) is a side view showing the state of usage of the massaging apparatus and (2) is a perspective view of the massaging apparatus seen from behind.

### DESCRIPTION OF THE PREFERRED EMBODIMENTS

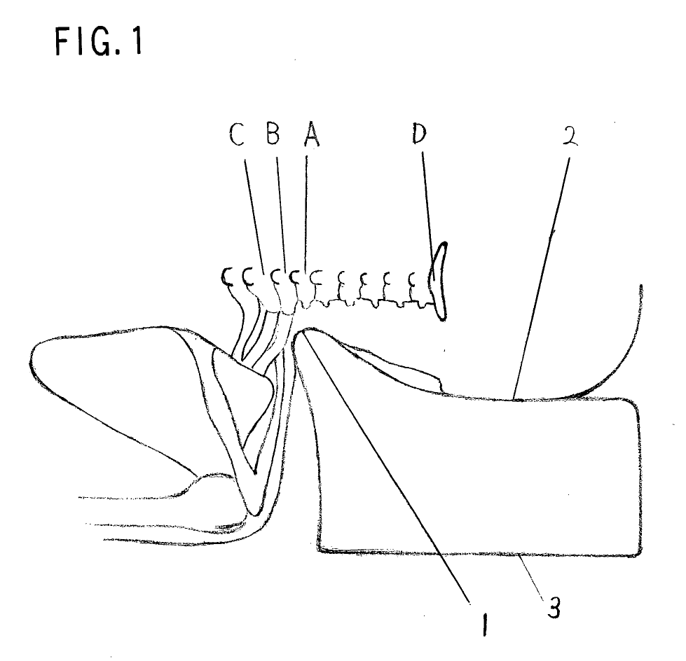

Referring now to FIG. 1 to FIG. 13, embodiments of the invention will be described.

FIG. 1 is a drawing showing a state in which an obliquely projecting projection 1 is placed to a boundary portion between the right shoulder and the root of the neck, the head is placed on a head rest portion 2, the weight of the head prevents a massaging apparatus from being displaced upwardly of the head, and the right shoulder and the neck are pressed strongly to alleviate the stiffness.

Since a bottom portion 3 is formed of an anti-slippery material, it functions to prevent the displacement.

The bottom portion 3, except for the type shown in FIG. 1, has a wide surface area using known means such as a slide, thereby giving a stability to the massaging apparatus.

A user is able to massage him/herself by shaking his/her body. Reference sign A designates a seventh cervical vertebra, reference sign B designates a first thoracic vertebra, reference sign C designates a second thoracic vertebra, and reference sign D designates a first cervical vertebra.

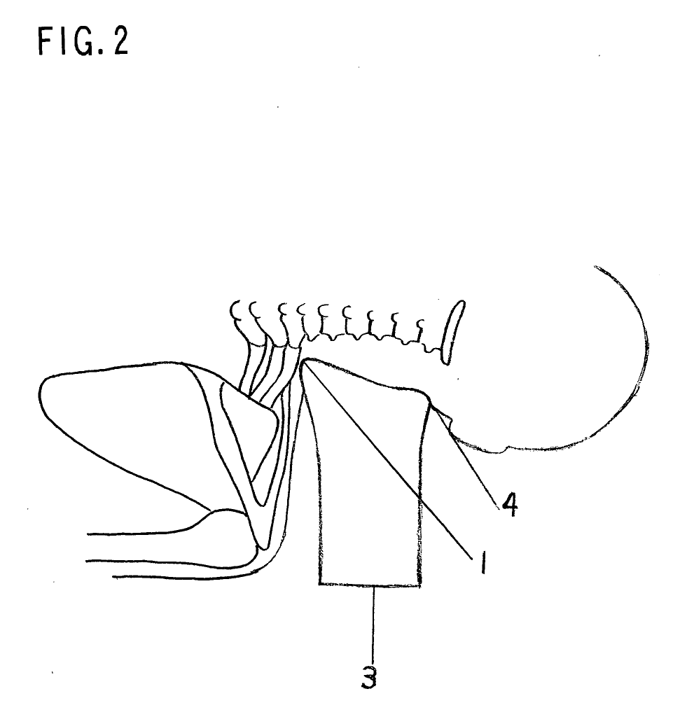

FIG. 2 is a drawing showing a state in which the obliquely projecting projection 1 is placed on the boundary portion between the right shoulder and the neck, and a neck side projection 4 is placed on the boundary portion between the head and the neck, so that a pressing force is applied in the same direction as in the drawing of a first point of the regio cervicalis lateralis in p. 91 2 of Illustration/Basic Manipulation Method, Total Body Adjustment by Massage and Acupressure, and hence the massaging apparatus in the invention is prevented from being displaced toward the head and the stiffness of the right shoulder and the neck is alleviated by being strongly pressed. As shown in Illustration/Basic Manipulation Method, Total Body Adjustment by Massage and Acupressure 4 in the first row of p. 92, the regio cervicalis posterior, between the depression of regio cervicalis posterior and the temporal region of head, the first point immediate below the skull, since the force of acupressure is applied to the first point of the regio cervicalis posterior in the same direction as the first point of the temporal region of head, the apparatus is hardly displaced toward the head. Since the bottom portion 3 is formed of the anti-slippery material, it helps to prevent slippage of the apparatus.

There is the one with the bottom portion 3 having a narrow surface area as in the drawing. There is the type having the bottom portion 3 narrower than that, which may be used in such a manner that the apparatus is moved intentionally about the bottom portion 3 as a fulcrum when in use to give a massage. Alternatively, the massaging apparatuses in all the types shown here may be used in such a manner that the user moves his/her body with the massaging apparatus kept stable to give a massage.

There is a type having a function to give a massage over a wide area between the obliquely projecting projection 1 and the neck side projection 4. There is also a type having a function to give a massage over a wide area from the neck side projection 4 and the obliquely projecting projection 1 to the bottom portion 3.

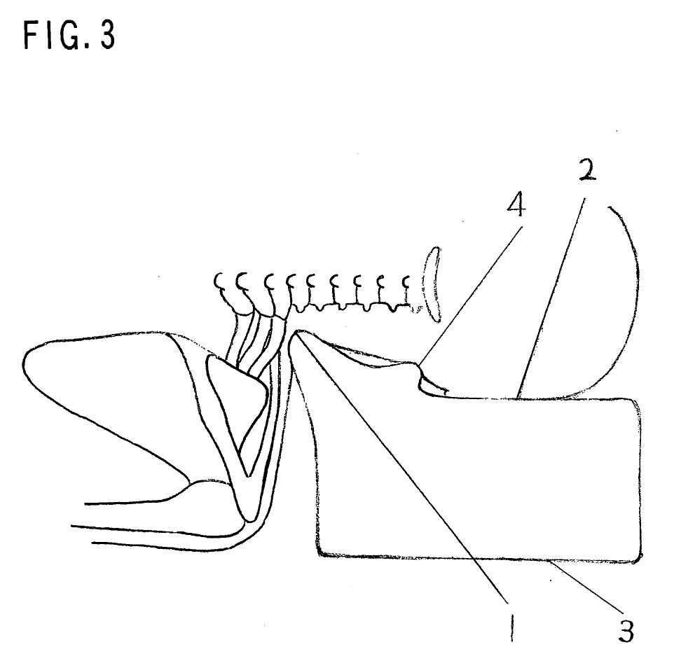

FIG. 3 is a view showing a state in which the massaging apparatus is extended in comparison with the one in FIG. 2 and the head rest portion 2 is integrated. The user is able to continue the massage to alleviate the stiffness as long as he/she wants in a relaxed manner.

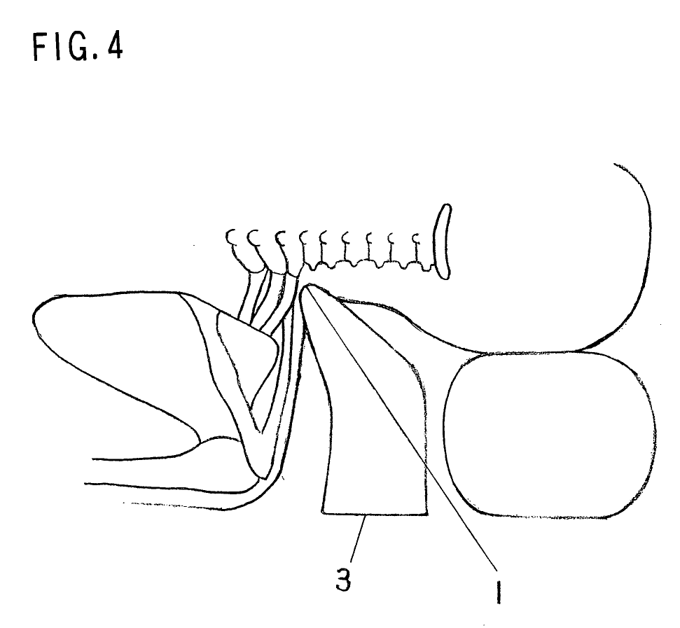

FIG. 4 shows a shape and structure in which the head rest portion 2 of the massaging apparatus shown in FIG. 1 is not provided, and a normal pillow is used instead of the head rest portion 2.

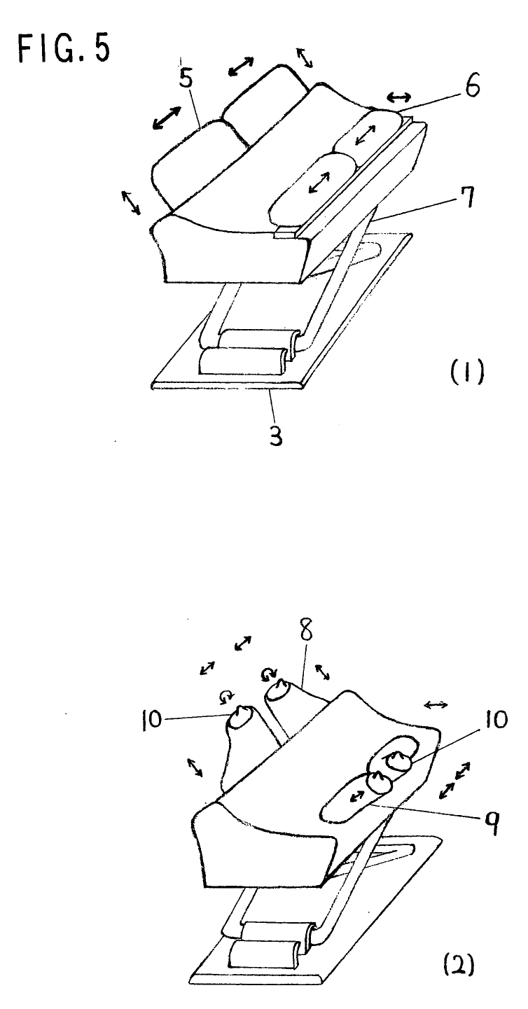

FIG. 5 shows an example of a general view of the massaging apparatus according to the invention.

An obliquely projecting projection 5 is configured to be opened separately for adjusting the width, although it is not separated in FIG. 5. A neck side projection 6 also has the same configuration. The widths of the obliquely projecting projection 5 and the neck side projection 6 are adjustable. Although not shown in the drawing, it is also possible to employ the structure in which the obliquely projecting projection 5 and the neck side projection 6 are driven to adjust the widths thereof as indicated by arrows in FIG. 5. In this configuration, alleviation of the stiffness in the deep portions on the shoulder side and in the neck side is achieved by driving these members to adjust the width thereof suitably according to the comfort of the user. The functions described thus far may be applied all the types of massaging apparatus. A pillow height adjusting unit 7 is configured to select the height. The function to adjust the height is a function which is able to be implemented in all the types of massaging apparatus.

(2) in FIG. 5 shows obliquely projecting projection 8 and the obliquely projecting 9 formed into a convex shape instead of the obliquely projecting projection 5 and the neck side projection 6. There are provided pinpoint massaging projections 10 which are moved by drive sources provided therein when a strong pressure is applied. The pinpoint massaging projections 10 are driven so as to rotate within a range which does not rub the skin too much and draw a small circle even when they are pressed strongly, and demonstrate a pinpoint massaging effect.

It is preferable to provide the obliquely projecting projections 5 and 8 at the same position as the obliquely projecting projection 1, and the neck side projection 6 and the obliquely projecting projection 9 at the same position as the neck side projection 4. The same drive and adjustment as in the type in (1) in FIG. 5 are possible in this case as well as indicated by arrows.

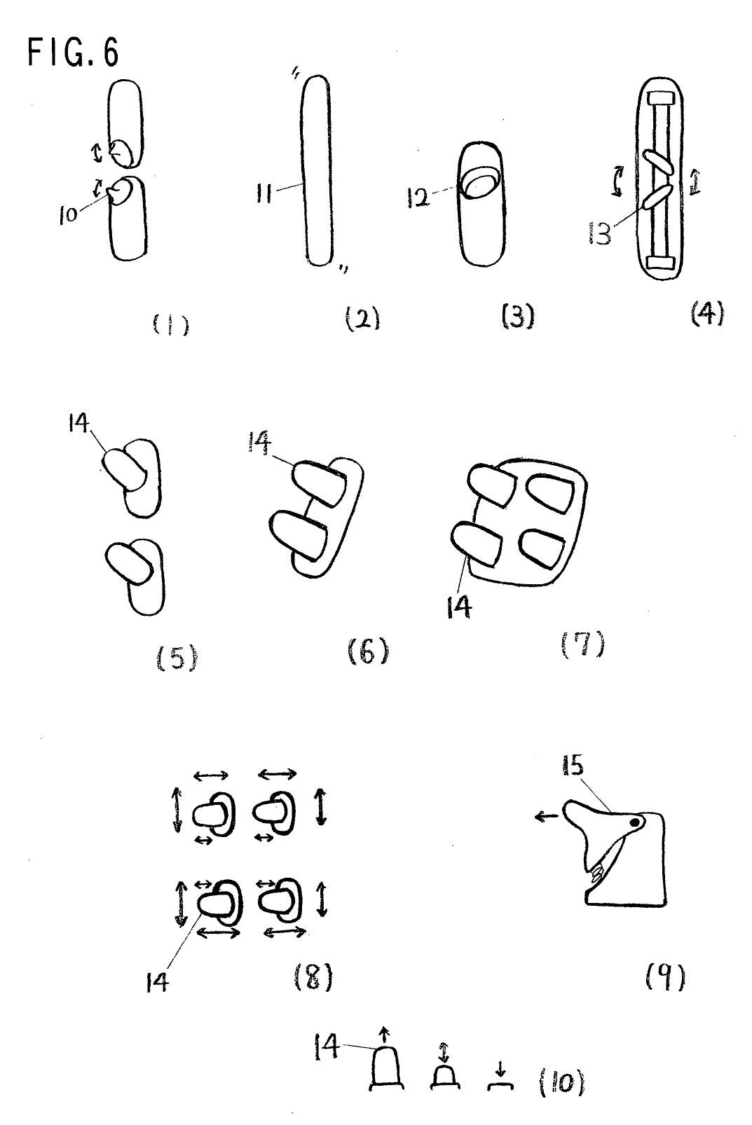

FIG. 6 show several examples of portions used in all the strong pressure massaging portions including the obliquely projecting projections 1, 5, 8 and 9 and the neck side projections 4 and 6 of the massaging apparatus for giving a strong acupressure massage to the human body.

(1) in FIG. 6 shows a rotating pinpoint massaging projections 10 provided at the distal ends of the contact points on the divided portions of the obliquely projecting projections 1, 5, 8 and 9 and the neck side projections 4 and 6 which rotate by motive power and alleviate the stiffness by its strong acupressure massage and the kneading effect. The rotation may be clockwise or counterclockwise, and may be located at the intermediate portions or the lower end portions instead of the distal end portions. With this function, the methods of pressing, kneading and strongly rubbing described in pp. 4-7 in Illustration/Basic Manipulation Method, Total Body Adjustment by Massage and Acupressure, which are terms used in the field of manipulation therapy, are carried out at once.

(2) in FIG. 6 shows a vibrator 11 which has a function to alleviate the stiffness of the body at the obliquely projecting projections 1, 5, 8 and 9 and the neck side projections 4 and 6 separately or entirely. With this function, the methods of vibrating and tapping as shown above in Illustration/Basic Manipulation Method, Total Body Adjustment by Massage and Acupressure are added, pressing, kneading, vibrating, tapping, and strongly rubbing are carried out at once.

(3) in FIG. 6 illustrates the movement of a roller massaging portion 12 to be used for the obliquely projecting projections 1, 5, 8 and 9 and the neck side projections 4 and 6 in which a roller is moved in the interior thereof.

(4) in FIG. 6 illustrates a rolling massaging portion 13 to be used for the obliquely projecting projections 1, 5, 8 and 9 and the neck side projections 4 and 6, in which the massaging effect is achieved by differentiating the distance between the rollers.

(5) to (7) in FIG. 6 illustrate massaging portions having one to four pressing projections 14 which demonstrate a high massaging effect even without motive power. Of course, the one having the pressing projection 14 and the motive power provided at the distal end thereof may be adopted. There may be four or more of those.

(8) in FIG. 6 illustrates the four pressing projections 14 which are able to be adjusted in twelve directions indicated by arrows.

(9) in FIG. 6 illustrates a shoulder pressing helper 15, which helps to apply the pressing force to the interior of the body, that is, to the deep portion in the direction indicated by an arrow when the shoulder pressing helper 15 comes into contact with the boundary portion between the shoulder and the neck.

(10) in FIG. 6 illustrates a massaging portion of a type having the pressing projection 14 which moves upward and downward by the motive power. When it is moved upward, it presses the human body. When it is moved downward, the pressing projection 14 is depressed and, in this state, it does not press the human body. This is the movement like so-called Whack-A-Mole game. It also explains that the pressing projection 14 is moved upward and downward without the motive power and using a resilient member such as a spring or the like according to the pressing strength.

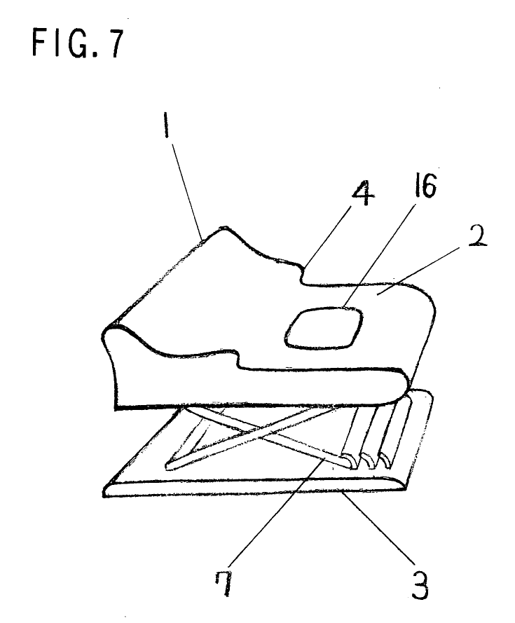

FIG. 7 shows an example having a speaker 16 for hearing a peripheral sound. A sound collecting hole may be provided instead of the speaker 16.

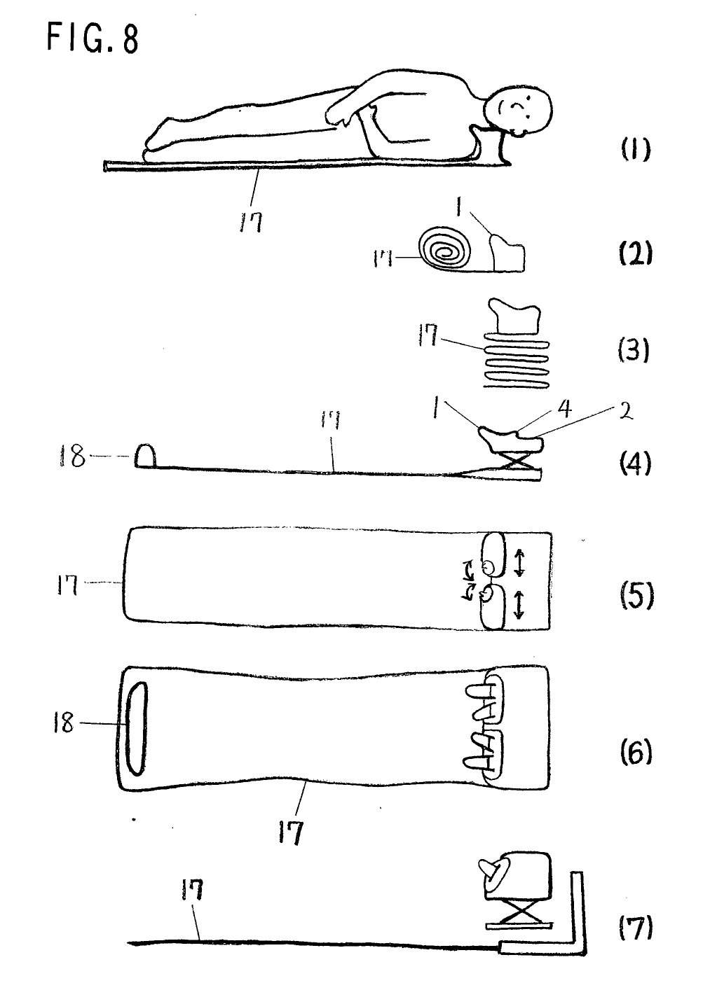

(1), (5) and (7) in FIG. 8 show examples having a mat 17 for preventing the massaging apparatus from being displaced. Specifically, this mat 17 has an effect to prevent the massaging apparatus from being displaced toward the head when pressing the root of the neck. The mat 17 may be configured to be detachable.

(2) in FIG. 8 illustrates a state in which the mat 17 is rolled for storage.

(3) in FIG. 8 illustrates a state in which the mat 17 is folded for storage.

(4) and (6) in FIG. 8 illustrate examples having a foot rest portion 18 provided at the end of the mat 17 for placing the feet and ensuring stimulus for the stiffed portion or giving a stronger pressing force easily and comfortably when the mat 17 is moved or displaced.

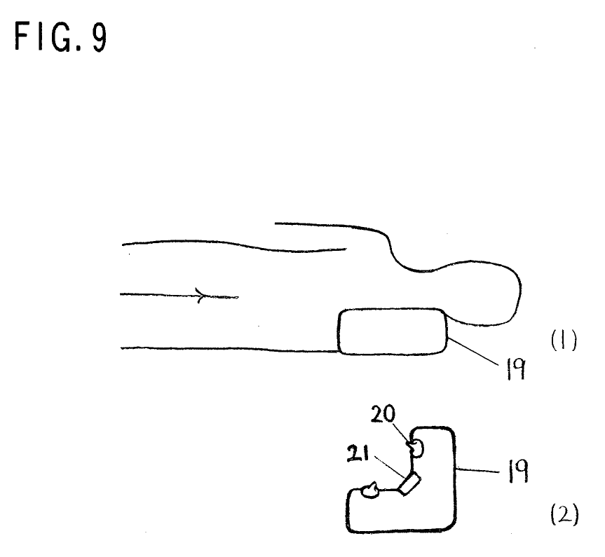

(1) and (2) in FIG. 9 illustrate a massaging apparatus 19 having an L-shape as an entirety, which is suitable to be used in the lying-down position both on the left and right sides. It has a shape fitting the portion from the root of the neck to the portion near the shoulder and the back to allow a strong pressing massage. It includes a pinpoint massaging projection 20 and a vibrator 21.

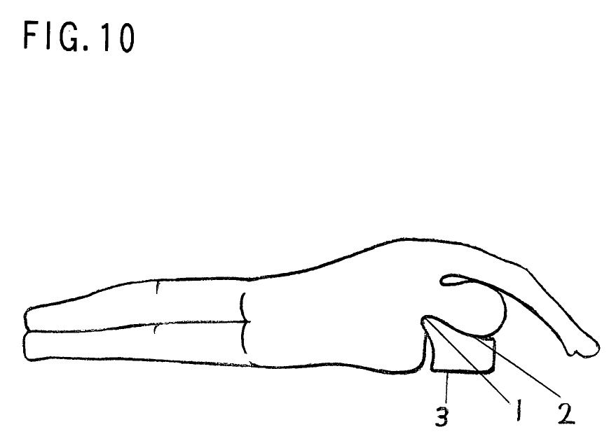

FIG. 10 is a drawing applied to all the massaging apparatuses in the invention. There is a description of “4. Knacks of massage and acupressure” in the reference from line 35 in p. 2 to line 16 in p. 3. Even when the patient gives a massage described in this reference to him/herself, the massage is easily given to the deep portion at the boundary portion between the shoulder and the neck with the massaging apparatus according to the invention which gives acupressure strongly only to one side in the lying-down position. As an example, as shown in FIG. 10, by moving the arm on the upper side on the side which is not pressed strongly to the limit of movable range of the articular movement and relaxing, the obliquely projecting projection 1 is pressed against the stiffed portion further strongly.

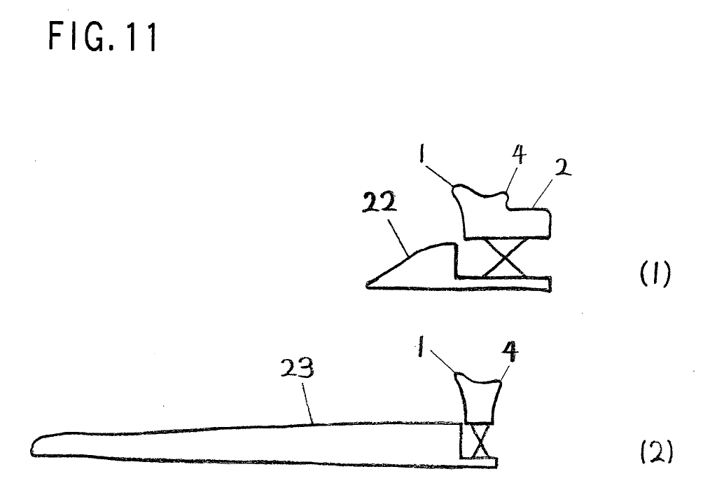

(1) in FIG. 11 illustrates the massaging apparatus in the invention provided with a massaging portion 22 at an extended portion thereof. (2) in FIG. 11 illustrates the massaging apparatus in the invention provided with a massaging portion 23 at the extended portion thereof.

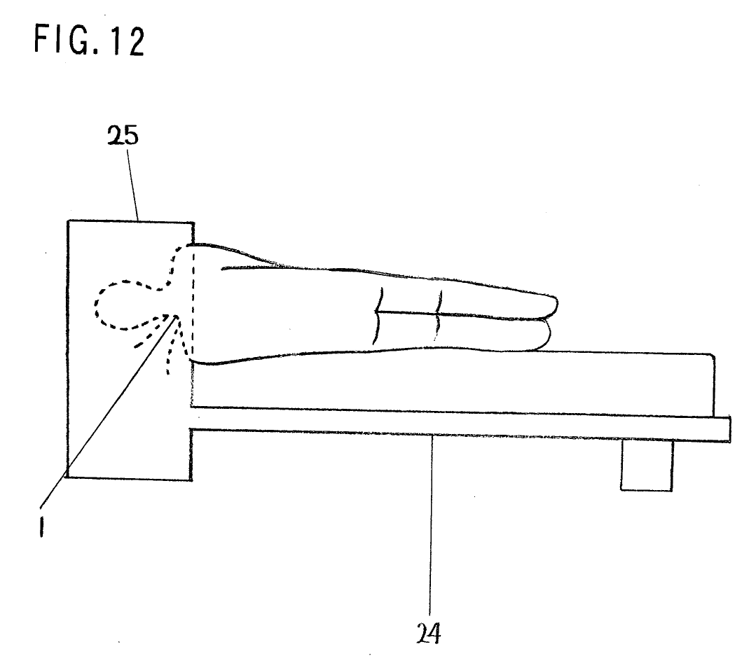

FIG. 12 is an explanatory drawing showing that the massaging apparatus may be used as a bed.

The user takes the lying-down position on a bed 24, and uses the massaging function provided in a head rest 25. Although not shown in the drawing, it is possible that the massaging function may be provided during use when a cover or a part thereof is opened or is removed by the known measure. Therefore, when it is not in use, the appearance is good. The height of the massaging function is adjustable.

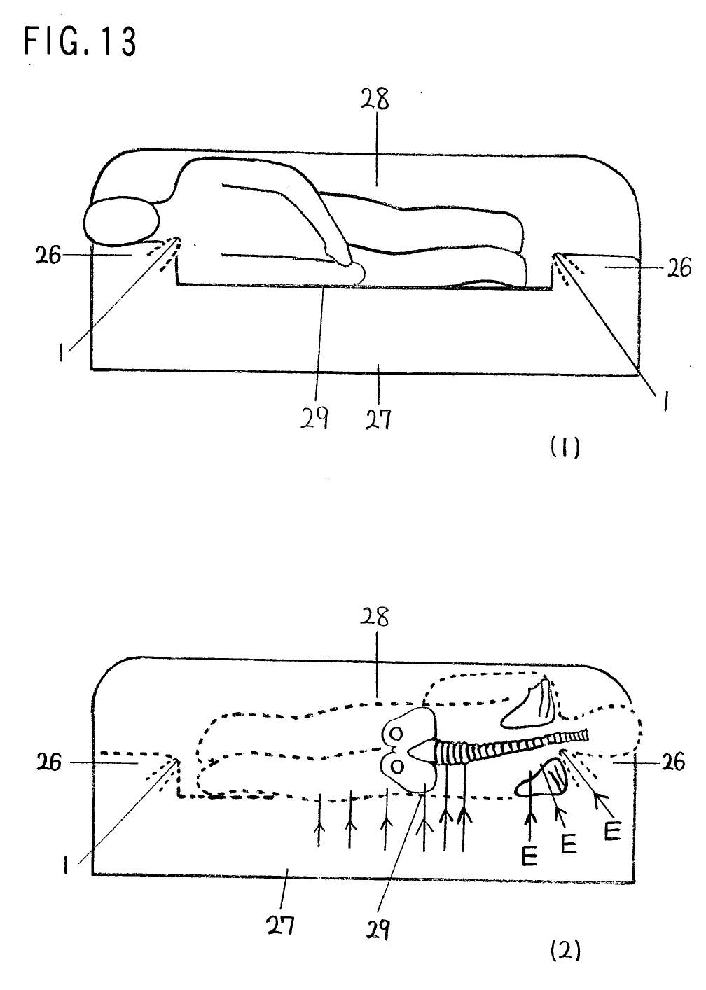

(1) in FIG. 13 illustrates an arm rest 26 provided with the obliquely projecting projection 1, which may be used as a sofa 27. It shows a state in which the user takes the lying-down position, and places the body in tight contact with a seat back 28 and a seating surface 29 and gives a strong acupressure massage to the deep portion at the boundary portion between the shoulder and the neck by the massaging function provided in the arm rest 26. Although not shown in the drawing, it is possible that the massaging function may be provided during use when a cushion or a part thereof is opened or is removed by the known measure. Therefore, when it is not in use, the appearance is good. The height of the massaging function is adjustable. Of course, the massaging is available at the arm rests 26 on both sides.

(2) in FIG. 13 is a perspective view of the sofa 27 in (1) in FIG. 13 when viewed from the back side and viewing the back of the body. A strong acupressure massage is given to the deep portion at the boundary portion between the shoulder and the neck with the massaging function provided in the arm rest 26. In addition, an acupressure massage may be given to plurality of portions of the body from the seat back 28 and the seating surface 29 as shown by arrows in the drawing. The arrows E are applied to all the massaging apparatuses, and show that the back side of the shoulder blades, which are hidden in the normal posture and hence cannot be touched since they turn outward, are massaged to alleviate the stiffness of the erector muscle of spine. Accordingly, the acupressure and massage are enabled together with a stretching effect.

The functions described above are functions which may be implemented in all the types of massaging apparatuses, and some of characteristics may be combined.

Subsequently, characteristics of all the massaging apparatuses according to the invention, and medical approach to muscles and nerves will be described in brief.

A surface to which the human body touches may be formed of an elastic material or a flexible material. When employing a rigid material, a structure using a spring or the like to achieve the structure or the material which gives the user a soft feeling and feeling of security when it touches the human body may be employed. The portion to which the back bone comes into contact may be formed into a depressed shape.

When the stiffness on the shoulder side is serious, the side having a large surface area is used for the head side to alleviate the pressing force and the stimulus, and the side having a smaller surface area is used for the shoulder side to increase the pressing force and stimulus. Alternatively, various modifications may be applied such as to inverse the combination, and the stimulus in use of the projections may be considered so as to meet the head side and the boundary portion between the shoulder and the head. In order to do so, there is a type in which the projections are replaceable.

Adjustment to move only the shoulder side upward and downward or to move only the head side is also possible. The distance between the projections, the width of the projections and the height of the projections are adjustable, and hence the acupressure massage which meets the symptom of the individual is achieved.

When a strong pressing force is applied, the direction of the pressing force applied to the human body by the massaging apparatus matches the direction of the stiffness at the deep portion at the boundary portion between the shoulder and the neck. On the other hand, a force which presses the massaging apparatus substantially right downward is applied to the massaging apparatus. Therefore, the massaging apparatus is hardly displaced by itself.

A type in which motive power is provided to each projection to give a massage is also contemplated. The massaging function using the motive power includes the projection as a matter of course, and also a projection or convex-concavity which rotates, vibrates or slides by a known motive power on the upper surface of the projection.

As an additional description, the projection for applying a pressing massage to the human body moves, if it is a type having a motive power, entirely, partly or only at the distal end thereof by a known drive unit. Also, there is the massaging apparatus in which the entire part is able to vibrate and move, or is able to make a combined movement including vibration, movement and tapping. A remote control or a switch for selecting a timer function, massage, strength and combination may also be provided.

The projection may be of a type which moves upward or downward by a motive power. When it is moved downward, the projection is depressed, so that it does not press the human body. There is also a type having the same function to move upward and downward without motive power.

The massaging apparatus in the related art gives a massage in a state in which the user is in the face-up position, or the face-up position to the sitting position. Therefore, in these postures, the shoulder blades are positioned close to the vertebra column. In this state, the shoulder blades are positioned close to the vertebra column than the state where the human being is stand upright, muscles on the back side of the erector muscle of spine or the shoulder blades are hidden, and hence the stiffness of this part cannot be alleviated.

In contrast, the massaging apparatus in the invention is a massaging apparatus in which the user uses the massaging apparatus in the lying-down position and, in this state, the shoulder blades are turned outward and hence are apart from the vertebra column so that the stiffness is alleviated. Therefore, the stiffness of the erector muscle of spine or other muscles which could not be alleviated in the face-up position because they are hidden behind the shoulder blades is successfully alleviated.

This position makes the muscle having the fixed origin at the vertebra column and a movable terminal at the shoulder blades, which is the muscle which connects the upper limb to the vertebra column, stretched. The method of stretching the stiffed muscle and pressing the stiffed muscle to alleviate the stiffness is very effective. This theory is medically effective in therapy of the human body.

The part which is effective for alleviating the stiffness of the shoulder according to the medical books or references and contains nerves which controls the rhomboieus muscle, scapular erector, subclavius muscle, suprasipinatus muscle, infraspinous muscle, subscaplaris muscle, musclus teres, musclus teres minor, deltoid muscle, and muscles of upper limb, which are muscles to be subject to the stiffness located near the neck and shoulder to be massaged by the acupressure, is a portion near the neck and shoulder from cervical vertebra C4 to thoracic vertebra TH2. By pressing the left and right side of the vertebral column individually from the cervical vertebra C4 to thoracic vertebra TH2, the stiffness of the deep portion at the boundary portion between the shoulder and the neck can be alleviated effectively. It is also possible to alleviate the stiffness from C1 to C3 by the projections for pressing and massaging the boundary portion between the head and the neck. Since a bundle of nerves called “brachial plexus” passes through the deep portions of the shoulder and the neck, giving an acupressure and massage thereto is very effective as a therapy.

However, in order to find and alleviate the stiffness of a pinpoint which exists at the deep portion at the boundary portion between the shoulder and the neck, which is not such a large area and is not described in the medical books or the references and is specifically effective to give a therapy, the massaging portion is placed on the skin above the pinpoint at the deep portion, and gives a massage by pressing the pinpoints intensively. When the stiffness of the portion in question is alleviated gradually, the pinpoint appears, so that the stiffness of the pinpoint is alleviated. The method of alleviating the stiffness of the pinpoint could be found by the inventor because the inventor has been devoted himself to practice and study how to alleviate the pinpoint with the massaging apparatus for a long time, and this invention is a result of study of the inventor while concentrating on the therapy.

1. A massaging apparatus comprising a projection projecting obliquely toward the root of the neck of a user when the user stabilizes his/her head in the lying-down position.

2. The massaging apparatus according to claim 1, comprising a projection projecting obliquely toward the seventh cervical vertebra of the user.

3. The massaging apparatus according to claim 1, comprising a head rest portion for placing the head of the user.

4. The massaging apparatus according to claim 1, comprising a neck side projection to be placed on the boundary portion between the head and the neck of the user so as to face the obliquely projecting projection.

5. The massaging apparatus according to claim 1, wherein the obliquely projecting projection is provided at an angle from 30 to 60° with respect to a main body of the massaging apparatus.

6. The massaging apparatus according to claim 1, wherein the obliquely projecting projection is drivable.

7. The massaging apparatus according to claim 1, comprising a drivable pinpoint massaging projection at an upper end of the obliquely projecting projection.

8. The massaging apparatus according to claim 1, characterized by being usable as a pillow.

9. The massaging apparatus according to claim 1, characterized by being usable as a bed.

10. The massaging apparatus according to claim 1, comprising an obliquely projecting projection in an arm rest, characterized by being usable as a sofa.
